(19) United States
(12) Patent Application Publication
(10) Pub. No.: US 2024/0263007 A1
(43) Pub. Date: Aug. 8, 2024

(54) COMPOSTABLE PLASTIC WRAP

(71) Applicant: NAN YA PLASTICS CORPORATION, TAIPEI (TW)

(72) Inventors: TE-CHAO LIAO, Taipei (TW); TENG-KO MA, Taipei (TW); CHING-YAO YUAN, Taipei (TW)

(21) Appl. No.: 18/304,362

(22) Filed: Apr. 21, 2023

(30) Foreign Application Priority Data
Feb. 3, 2023 (TW) 112103795

(51) Int. Cl. C08L 71/08; B65D 65/22; B65D 65/46

(52) U.S. Cl. CPC C08L 71/08; B65D 65/22; B65D 65/466; C08L 2201/06; C08L 2203/162

(57) ABSTRACT

A compostable plastic wrap is provided. Based on a total weight of the compostable plastic wrap being 100 wt %, a material of the compostable plastic wrap includes more than 90 wt % of polybutylene adipate terephthalate. In a cross-sectional structure of the compostable plastic wrap, the compostable plastic wrap has a center area and a surface area. The center area is completely encapsulated by the surface area. The center area contains an oleate compound, or the surface area contains an ether compound.

### CROSS-REFERENCE TO RELATED PATENT APPLICATION

This application claims the benefit of priority to Taiwan Patent Application No. 112103795, filed on Feb. 3, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic wrap, and more particularly to a compostable plastic wrap.

### BACKGROUND OF THE DISCLOSURE

A plastic wrap is a common food-packaging product, through which dishes can be kept fresh and be prevented from getting mixed with other odors after being placed in a refrigerator. The plastic wrap is widely used in a common household. However, the plastic wrap is a disposable packaging product that needs to be discarded each time after use. In the long run, the discarded plastic wrap becomes a burden to the environment.

Moreover, the plastic wraps that are currently available on the market are mostly made of petrochemical plastic (such as polyvinyl chloride or polyethylene), which hardly decomposes in the natural environment. As such, using the plastic wrap is not environmentally friendly, which is an issue that has garnered widespread attention.

Since the plastic wrap does not easily decompose, countries around the world are aiming to increase a decomposition rate of the plastic wrap, so as to reduce the environmental pollution caused by the disposable plastic wrap.

Some plastic wraps are manufactured with addition of an oxidative degradation additive, and are claimed to be oxidatively degradable. However, the European Union has confirmed that although such plastic wraps can be disintegrated into plastic fragments, the plastic fragments still cannot be decomposed by the environment. Moreover, these plastic fragments contain heavy metal components, which can cause even more serious environmental damage. Hence, the oxidative degradation additive is prohibited from use.

Therefore, how to improve the biodegradability of the plastic wrap through material-related improvements, so as to overcome the above-mentioned problem, has become one of the important issues to be solved in the industry.

### SUMMARY OF THE DISCLOSURE

In response to the above-referenced technical inadequacy, the present disclosure provides a compostable plastic wrap.

In order to solve the above-mentioned problem, one of the technical aspects adopted by the present disclosure is to provide a compostable plastic wrap. Based on a total weight of the compostable plastic wrap being 100 wt %, a material of the compostable plastic wrap includes more than 90 wt % of polybutylene adipate terephthalate. In a cross-sectional structure of the compostable plastic wrap, the compostable plastic wrap has a center area and a surface area completely encapsulating the center area. The center area contains an oleate compound, or the surface area contains an ether compound.

In one of the possible or preferred embodiments, a molecular weight of the oleate compound ranges from 350 g/mol to 450 g/mol.

In one of the possible or preferred embodiments, a molecular weight of the ether compound ranges from 150 g/mol to 250 g/mol.

In one of the possible or preferred embodiments, based on the total weight of the compostable plastic wrap being 100 wt %, an amount of the oleate compound ranges from 0.3 wt % to 1.5 wt %.

In one of the possible or preferred embodiments, based on the total weight of the compostable plastic wrap being 100 wt %, an amount of the ether compound ranges from 0.3 wt % to 1.5 wt %.

In one of the possible or preferred embodiments, based on the total weight of the compostable plastic wrap being 100 wt %, the material of the compostable plastic wrap further includes 3 wt % to 7 wt % of polybutylene succinate.

In one of the possible or preferred embodiments, based on a total thickness of the compostable plastic wrap being 100%, a thickness of the center area ranges from 60% to 90%.

In one of the possible or preferred embodiments, the surface area further contains an amide compound, and the amide compound has a molecular weight that ranges from 200 g/mol to 500 g/mol.

In one of the possible or preferred embodiments, based on the total weight of the compostable plastic wrap being 100 wt %, an amount of the amide compound ranges from 0.1 wt % to 0.3 wt %.

In one of the possible or preferred embodiments, the surface area further contains polyisobutylene and the polyisobutylene has a molecular weight that ranges from 200 g/mol to 10000 g/mol.

In one of the possible or preferred embodiments, based on the total weight of the compostable plastic wrap being 100 wt %, an amount of the polyisobutylene ranges from 0.5 wt % to 1.5 wt %.

Therefore, in the compostable plastic wrap provided by the present disclosure, by virtue of “a material of the compostable plastic wrap including more than 90 wt % of polybutylene adipate terephthalate” and “the center area containing an oleate compound, or the surface area containing an ether compound,” the compostable plastic wrap can have good functional properties and good decomposability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a compostable plastic wrap of the present disclosure; and

FIG. 2 is a schematic cross-sectional view taken along line II-II of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to overcome poor decomposability of conventional plastic wraps (which are a burden to the environment), the present disclosure provides a compostable plastic wrap. According to the EN13432/ASTMD6400 test method, the compostable plastic wrap of the present disclosure can be completely decomposed by compost within 180 days. Moreover, since the material of the compostable plastic wrap does not contain metal additives, the compostable plastic wrap will not cause secondary pollution to the environment after being decomposed.

The compostable plastic wrap of the present disclosure is formed by using polybutylene adipate terephthalate (PBAT) as a main component, such that the compostable plastic wrap can have good decomposability. Based on a total weight of the compostable plastic wrap being 100 wt %, an amount of the polybutylene adipate terephthalate is more than 90 wt %, such as 91 wt %, 92 wt %, 93 wt %, 94 wt %, 95 wt %, 96 wt %, or 97 wt %.

In addition to the polybutylene adipate terephthalate, the material of the compostable plastic wrap further includes polybutylene succinate (PBS), so that the compostable plastic wrap has a certain stiffness. However, an excessive amount of the polybutylene succinate can result in high raw material costs. Based on the total weight of the compostable plastic wrap being 100 wt %, an amount of the polybutylene succinate ranges from 3 wt % to 7 wt %, such as 4 wt %, 5 wt %, or 6 wt %.

In order to meet use requirements, some functional additives are added to the plastic wraps, so that the plastic wraps can have good transparency, a good anti-fog ability, and good packaging properties (hereinafter referred to as functional properties).

In order to possess the decomposability and the functional properties, a specific compound is chosen and added in a specific area of the compostable plastic wrap of the present disclosure. In this way, under the premise of having good functional properties, the compostable plastic wrap of the present disclosure can further have good compost decomposability.

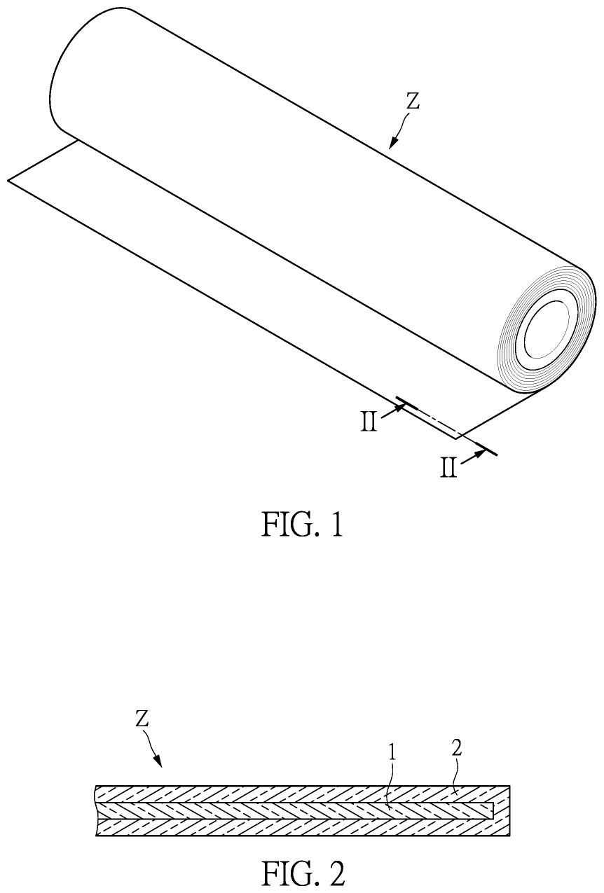

Referring to FIG. 1 and FIG. 2, in a cross-sectional structure, a compostable plastic wrap Z of the present disclosure has a center area 1 and a surface area 2. The center area 1 is completely encapsulated by the surface area 2.

It should be noted that the material of the center area 1 is substantially the same as the material of the surface area 2, both of which contain polybutylene adipate terephthalate (PBAT) as a main component. In addition, polybutylene succinate (PBS) can be selectively added. The difference between the center area 1 and the surface area 2 is that different specific compounds are added in the center area 1 and the surface area 2.

Therefore, in terms of product appearance, the center area 1 and the surface area 2 are integrally formed. However, by analyzing the contained components, the compostable plastic wrap Z can be divided into the center area 1 and the surface area 2.

In one exemplary embodiment, a thickness of the compostable plastic wrap Z ranges from 5 μm to 20 μm, such as 7 μm, 9 μm, 11 μm, 13 μm, 15 μm, 17 μm, or 19 μm. Based on a total thickness of the compostable plastic wrap Z being 100%, a thickness of the center area 1 ranges from 60% to 90%. For example, the thickness of the center area 1 accounts for 70% to 80% of the total thickness of the compostable plastic wrap Z.

In the present disclosure, an oleate compound can be selectively added into the center area 1, an ether compound can be selectively added into the surface area 2, or the oleate compound and the ether compound can be respectively added into the center area 1 and the surface area 2 at the same time. Accordingly, the compostable plastic wrap Z can have good functional properties and good decomposability.

The oleate compound and the ether compound are incompatible with PBAT, so that the oleate compound and the ether compound will slowly migrate toward a surface of the compostable plastic wrap Z and lose their effects. In order to ensure that the oleate compound and the ether compound are contained in the compostable plastic wrap Z, molecular weights of the oleate compound and the ether compound can be controlled to reduce migration of the oleate compound and the ether compound.

Specifically, the molecular weight of the oleate compound is greater than the molecular weight of the ether compound. The molecular weight of the oleate compound can range from 350 g/mol to 450 g/mol, such as 375 g/mol, 400 g/mol, or 425 g/mol. The molecular weight of the ether compound can range from 150 g/mol to 250 g/mol, such as 175 g/mol, 200 g/mol, or 225 g/mol.

The oleate compound and the ether compound are disposed in different areas, such that migration times of the oleate compound and the ether compound are different. The oleate compound is disposed in the center area 1, such that the oleate compound is contained in the compostable plastic wrap Z for a longer period of time as compared to the ether compound disposed in the surface area 2. As such, when the oleate compound is contained in the center area 1 and the ether compound is contained in the surface area 2, the compostable plastic wrap Z can have good functional properties for a long time.

In one exemplary embodiment, based on the total weight of the compostable plastic wrap being 100 wt %, an amount of the oleate compound ranges from 0.3 wt % to 1.5 wt %.

In one exemplary embodiment, based on the total weight of the compostable plastic wrap being 100 wt %, an amount of the ether compound ranges from 0.3 wt % to 1.5 wt %.

In addition, the oleate compound and the ether compound selected in the present disclosure have high hydrophilicities. In this way, it is difficult for water to cover the surface of the compostable plastic wrap or only small water droplets are attached to the surface of the compostable plastic wrap in a low-temperature storage condition. In one exemplary embodiment, the oleate compound can be sorbitan monooleate, and the ether compound can be polyoxyethylene ether.

In one exemplary embodiment, an amide compound, calcium stearate, an organosilicon compound, or any combination thereof can be further added into the surface area 2, so as to improve the functional properties of the compostable plastic wrap Z.

Adding the amide compound, the calcium stearate, the organosilicon compound, or any combination thereof into the surface area 2 enables the compostable plastic wrap Z to be easily separable during a rolling process. Since easy separation is a surface property of the compostable plastic wrap Z, the amide compound, the calcium stearate, the organosilicon compound, or any combination thereof only needs to be added into the surface area 2 for achieving this purpose. Therefore, adding a specific component in the specific area is a technical feature of the present disclosure that allows a use amount of the amide compound, the calcium stearate, the organosilicon compound, or any combination thereof to be decreased.

In one exemplary embodiment, the amide compound (e.g., oleamide and erucamide) is added in the surface area 2. Compared to the calcium stearate or the organosilicon compound, the amide compound is more hydrophilic and can accelerate a bacterial decomposition rate of the compostable plastic wrap, thereby enhancing the decomposability. Based on the total weight of the compostable plastic wrap being 100 wt %, an amount of the amide compound ranges from 0.1 wt % to 0.3 wt %, such as 0.15 wt %, 0.20 wt %, or 0.25 wt %.

In one exemplary embodiment, a molecular weight of the amide compound ranges from 200 g/mol to 500 g/mol. For example, the molecular weight of the amide compound can be 250 g/mol, 300 g/mol, 350 g/mol, 400 g/mol, or 450 g/mol.

In one exemplary embodiment, polyisobutylene can be selectively added into the surface area 2, so as to improve the functional properties of the compostable plastic wrap Z. Based on the total weight of the compostable plastic wrap being 100 wt %, an amount of the polyisobutylene ranges from 0.5 wt % to 1.5 wt %, such as 0.75 wt %, 1.0 wt %, or 1.25 wt %.

Adding the polyisobutylene into the surface area 2 enables the compostable plastic wrap Z to be sticky enough for packaging or sealing up food. Since packaging or sealing of food relates to a surface property of the compostable plastic wrap Z, the polyisobutylene only needs to be added into the surface area 2 for achieving this purpose. Therefore, through adding the specific component in the specific area, a use amount of the polyisobutylene can be decreased in the present disclosure.

In one exemplary embodiment, a molecular weight of the polyisobutylene ranges from 200 g/mol to 10,000 g/mol. For example, the molecular weight of the polyisobutylene can be 500 g/mol, 1,000 g/mol, 1,500 g/mol, 2,000 g/mol, 3,000 g/mol, 4,000 g/mol, 5,000 g/mol, 6,000 g/mol, 7,000 g/mol, 8,000 g/mol, or 9,000 g/mol.

The compostable plastic wrap of the present disclosure is integrally formed by a blown film process. Appropriate amounts of plastic chips (PBAT and PBS) are weighed by a loss-in-weight feeder, and then the plastic chips are mixed with each other by a mixer. Since the center area 1 and the surface area 2 have different compositions, a center area material and a surface area material are independently prepared.

Subsequently, a rotation speed of an extruder and a flow rate and a temperature of cooling air are adjusted according to a width of a film. The film is formed by being blown upward. After being blown and cut, the film is fixed by a clamping wheel, and a drawing speed and a tension force are controlled to roll the film.

The center area material and the surface area material are used to form a center layer film and a surface layer film, respectively. One center layer film is disposed between two surface layer films. After being co-extruded, the compostable plastic wrap Z is integrally formed. Since the center layer film and the surface layer film have similar composition, the center layer film and the surface layer films are integrally connected with each other, and the center layer film is completely encapsulated by the surface layer films. The center area 1 of the compostable plastic wrap Z is formed by the center layer film, and the two surface layer films merge to form the surface area 2.

In order to prove that the compostable plastic wrap Z of the present disclosure has good functional properties and good decomposability, the compostable plastic wrap Z of Examples 1 to 3 and the plastic wraps of Comparative Examples 1 and 2 are manufactured according to compositions listed in Table 1 and by the above-mentioned blown film process and co-extrusion process.

Physical properties of the compostable plastic wrap Z of Examples 1 to 3 and the plastic wraps of Comparative Examples 1 and 2 are measured and listed in Table 2. The physical properties in Table 2 are measured according to the GB/T 10457-2021 test method. In an anti-fog ability test, “excellent” represents a high anti-fog ability in which a content can be clearly observed, “good” represents a middle anti-fog ability in which only slight fog is formed, and “poor” represents a low anti-fog ability in which the content cannot be clearly observed.

TABLE 1

| | | | | Comparative | | |
|---|---|---|---|---|---|---|
| | Example | | | Example | | |
| (phr) | 1 | 2 | 3 | 1 | 2 | |
| Center | PBAT | 96.6 | 94.55 | 95 | 100 | 94.55 |
| area | PBS | 2.5 | 5 | 5 | 0 | 5 |
| material | Oleate compound | 0.9 | 0.45 | 0 | 0 | 0.45 |
| | (sorbitan | | | | | |
| | monooleate) | | | | | |
| Surface | PBAT | 92.95 | 93.5 | 92.7 | 93.95 | 94.4 |
| area | PBS | 5 | 5 | 5 | 5 | 5 |
| material | Ether compound | 0 | 0.45 | 0.9 | 0 | 0.45 |
| | (polyoxyethylene | | | | | |
| | ether) | | | | | |
| | Amide compound | 0.15 | 0.15 | 0.15 | 0.15 | 0.15 |
| | (oleamide) | | | | | |
| | Polyisobutylene | 0.9 | 0.9 | 0.9 | 0.9 | 0 |

TABLE 2

| | | | | | | Comparative | |
|---|---|---|---|---|---|---|---|
| | | Standard | Example | | | Example | |
| | | requirements | 1 | 2 | 3 | 1 | 2 |
| Appearance | | Transparent | Milky | Milky | Milky | Milky | Milky |
| | | | white | white | white | white | white |
| Thickness | | ±3 | 9 | 9 | 9 | 9 | 9 |
| (μm) | | | | | | | |
| Transparency | | ≥85 | 91.2 | 92.6 | 92.1 | 91.5 | 91.9 |
| (%) | | | | | | | |
| Haze (%) | | ≤4 | 3.5 | 3.4 | 3.3 | 3.1 | 3.2 |
| Tensile | MD | ≥10 | 84 | 85 | 83 | 84 | 82 |
| strength | CD | ≥10 | 58 | 60 | 61 | 59 | 60 |
| (MPa) | | | | | | | |
| Elonga- | MD | ≥100 | 355 | 350 | 340 | 345 | 360 |
| tion rate | CD | ≥100 | 835 | 850 | 860 | 843 | 854 |
| (%) | | | | | | | |
| Right | MD | ≥40 | 140 | 145 | 150 | 151 | 148 |
| angle | CD | ≥40 | 147 | 150 | 155 | 152 | 153 |
| tear | | | | | | | |
| strength | | | | | | | |
| (N/mm) | | | | | | | |

| | | | | | | |
|---|---|---|---|---|---|---|
| Self-adhesion | ≥0.5 | 0.8 | 0.9 | 0.9 | 0.8 | 0.1 |
| property | | | | | | |
| (N/cm²) | | | | | | |
| Film-extension | Extension | 2 | 3 | 3 | 3 | 1 |
| property | within 5 | | | | | |
| (second) | seconds | | | | | |
| Anti-fog ability | — | Excel- | Excel- | Good | Poor | Excel- |
| | | lent | lent to | | | lent to |
| | | | good | | | good |

According to results in Table 1 and Table 2, the compostable plastic wrap of the present disclosure has advantages of high transparency and low haze. In addition, a tensile strength, an elongation rate, a right angle tear strength, a self-adhesion property, a film-extension property, and an anti-fog ability of the compostable plastic wrap all satisfy practical requirements. Therefore, the compostable plastic wrap of the present disclosure has similar functional properties as the plastic wrap currently on the market.

In comparison, the oleate compound and the ether compound are absent from the plastic wrap of Comparative Example 1, so that such a plastic wrap has a poor anti-fog ability. The polyisobutylene is absent from the plastic wrap of Comparative Example 2, so that such a plastic wrap has a poor self-adhesion property and cannot completely seal food or a container. The compostable plastic wrap of Example 2 undergoes a decomposability test according to the EN 13432/ASTM D6400 test method. It can be observed from the result that the compostable plastic wrap of the present disclosure is decomposable within 180 days. Further, the compostable plastic wrap of the present disclosure has been certified by Din Certco (in Europe) and the Biodegradable Products Institute (in the United States).

### BENEFICIAL EFFECTS OF THE EMBODIMENTS

In conclusion, in the compostable plastic wrap provided by the present disclosure, by virtue of “a material of the compostable plastic wrap including more than 90 wt % of polybutylene adipate terephthalate” and “the center area containing an oleate compound, or the surface area containing an ether compound,” the compostable plastic wrap can have good functional properties and good decomposability.

Further, in the present disclosure, through selecting and adding the specific component in the specific area, the functional properties of the compostable plastic wrap can be prolonged, and raw material costs can be decreased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A compostable plastic wrap, characterized in that, based on a total weight of the compostable plastic wrap being 100 wt %, a material of the compostable plastic wrap includes more than 90 wt % of polybutylene adipate terephthalate;
wherein, in a cross-sectional structure of the compostable plastic wrap, the compostable plastic wrap has a center area and a surface area completely encapsulating the center area, and the center area contains an oleate compound, or the surface area contains an ether compound.

2. The compostable plastic wrap according to claim 1, wherein a molecular weight of the oleate compound ranges from 350 g/mol to 450 g/mol.

3. The compostable plastic wrap according to claim 1, wherein a molecular weight of the ether compound ranges from 150 g/mol to 250 g/mol.

4. The compostable plastic wrap according to claim 1, wherein, based on the total weight of the compostable plastic wrap being 100 wt %, an amount of the oleate compound ranges from 0.3 wt % to 1.5 wt %.

5. The compostable plastic wrap according to claim 1, wherein, based on the total weight of the compostable plastic wrap being 100 wt %, an amount of the ether compound ranges from 0.3 wt % to 1.5 wt %.

6. The compostable plastic wrap according to claim 1, wherein, based on the total weight of the compostable plastic wrap being 100 wt %, the material of the compostable plastic wrap further includes 3 wt % to 7 wt % of polybutylene succinate.

7. The compostable plastic wrap according to claim 1, wherein, based on a total thickness of the compostable plastic wrap being 100%, a thickness of the center area ranges from 60% to 90%.

8. The compostable plastic wrap according to claim 1, wherein the surface area further contains an amide compound, and the amide compound has a molecular weight that ranges from 200 g/mol to 500 g/mol.

9. The compostable plastic wrap according to claim 8, wherein, based on the total weight of the compostable plastic wrap being 100 wt %, an amount of the amide compound ranges from 0.1 wt % to 0.3 wt %.

10. The compostable plastic wrap according to claim 1, wherein the surface area further contains polyisobutylene, and the polyisobutylene has a molecular weight that ranges from 200 g/mol to 10,000 g/mol.

11. The compostable plastic wrap according to claim 10, wherein, based on the total weight of the compostable plastic wrap being 100 wt %, an amount of the polyisobutylene ranges from 0.5 wt % to 1.5 wt %.
